(19) United States
(12) Patent Application Publication
(10) Pub. No.: US 2013/0014783 A1
(43) Pub. Date: Jan. 17, 2013

(54) METHOD FOR CLEANING SURFACES, IN PARTICULAR GLASS PANES

(71) Applicant: Claus Wandres, Stegen (DE)

(72) Inventor: Claus Wandres, Stegen (DE)

(73) Assignee: Wandres Brush-Hitec GmbH, Stegen (DE)

(21) Appl. No.: 13/637,882

(22) PCT Filed: Mar. 24, 2011
(86) PCT No.: PCT/DE2011/000309

§ 371 Date: Sep. 27, 2012

(30) Foreign Application Priority Data
Apr. 1, 2010 (DE) 10 2010 013 925.4

(51) Int. Cl. B08B 1/02; B65G 45/10

(52) U.S. Cl. 134/9; 15/256.5

(57) ABSTRACT

A method for cleaning glass surfaces, wherein the glass surface is transported relative to a cleaning device and the cleaning device moves a first, dampened microfiber cleaning face over the glass surface and a second microfiber cleaning face located downstream in the movement direction of the glass surface is moved over the glass surface.

### CROSS-REFERENCE TO RELATED APPLICATION

This application is a U.S. National Phase Patent Application based on International Application No. PCT/DE2011/000309 filed Mar. 24, 2011, the entire disclosure of which is hereby explicitly incorporated by reference herein.

### BACKGROUND OF THE INVENTION

1. Field of the Invention

The present invention is concerned with a device and a method for cleaning glass surfaces.

2. Description of the Related Art

Glass surfaces are usually coated after or during production to give the glass surface additional desirable properties. For the coating to be defect-free, however, the surface must be clear of foreign bodies. For one thing, it is impossible to completely prevent such undesirable impurities from contaminating the glass surface, and for another, it is sometimes essential for better handling to provide the glass surface with foreign bodies after production. For instance, plate glass is often stacked after production in order to store the glass pending further processing. Since sheets of plate glass are especially flat and high surface forces can therefore build up between them, it is difficult to separate two stacked sheets of plate glass. To make this separation possible, the glass surfaces are dusted with separating powder before being stacked, thus reducing the contact points and the forces between the surfaces. However, this separating powder must be carefully removed before the coating process so that no coating defects occur.

These glass surfaces must also be cleaned before undergoing further processing.

Washing systems are used for such cleaning in the prior art. In washing systems of this kind, the glass surface is rinsed off with demineralized water and cleaned on both sides with rotating brushes under continued rinsing. The surfaces are blown dry with a blower. Such washing systems are often up to 10 m long, with a power demand well above 40 kW.

### SUMMARY OF THE INVENTION

The present invention provides improved cleaning of glass panes, in particular cleaning options with a lower power demand and/or smaller spatial requirements.

The present invention also provides a method for cleaning glass surfaces in which the glass surface is conveyed relative to a cleaning device that moves a moistened microfiber cleaning surface over the glass surface. Downstream in the direction of movement of the glass surface, a second microfiber cleaning surface is moved over the glass surface and thus dries it.

“Glass surfaces” are understood here to include surfaces consisting not only of glass, but also wholly or partially of silicon, metal and/or the like.

“Microfiber” is understood here to mean a fiber of less than 1.0 dtex, particularly less than 0.7 dtex, preferably between 0.7 and 0.5 dtex. The term “microfibers” can also include fibers of less than 0.3 dtex. Such fibers can be made from polyester, polyacrylic, polyamide and/or cellulose. A mixture of polyester and polyamide is particularly preferred.

The use of microfibers to clean surfaces opens up the possibility of removing foreign bodies composed of greases, oils or similar viscous materials from the surface. This is difficult or impossible to achieve with brushes. The use of microfibers also permits lower consumption of cleaning fluid, such as demineralized water, for example, since the fine structures of the microfibers give the textile a large surface area and high capillary forces, as a result of which minuscule foreign bodies and/or fluids can easily be stripped from the surface and absorbed by the microfiber cleaning surface.

The microfiber cleaning surface comprises a microfiber textile, which consists primarily or exclusively of microfibers or has a multiplicity of microfibers on its surface. This textile can in particular be a nonwoven, crocheted and/or knitted fabric.

During the method, the glass surface is, in particular, moved relative to the cleaning device, for example on a conveyor belt or by means of driving or supporting rollers, so that a continuous cleaning process can be performed. In particular, part of the glass surface is already being dried by the second microfiber cleaning surface while a subsequent part of the glass surface is just being moistened with cleaning fluid by the first microfiber cleaning surface. It is also possible to clean a plurality of glass panes continuously in succession.

The first and/or second microfiber cleaning surface is, in particular, moved rectilinearly over the glass surfaces relative to the cleaning device. For instance, the microfiber cleaning surface can be moved transversely, in particular perpendicularly to the direction of movement of the glass surface. The microfiber cleaning surface can in this case extend over the entire width of the surface to be cleaned and thus clean the entire width of the glass surface simultaneously. Although it is possible to have the second microfiber cleaning surface moved by the first cleaning device, it is preferable to dispose the second microfiber cleaning surface on a second wiping element that is moved by a second cleaning device. A plurality—i.e., more than two—of cleaning devices disposed one after the other can also be used to achieve better cleaning performance.

The cleaning devices preferably each comprise one or more wiping elements having a closed, belt-like shape. “Closed shape” here means that the wiping elements have neither a beginning piece nor an end piece, but instead can be tensioned, like a machine belt, by means of two or more rollers, and thus form a rotating cleaning surface. The wiping elements in this case can rotate in the same direction or counter to each other.

The wiping element preferably forms at least two runs, both of which are guided approximately in parallel with the surface to be cleaned. The one run, particularly the bottom one, contacts the to-be-cleaned surface with the microfiber cleaning surface.

The microfiber cleaning surfaces are preferably disposed at least on the outer side of the belt-shaped wiping element, such that the microfiber cleaning surface is moved continuously on the glass surface by the wiping element and uninterrupted cleaning can thus be performed.

The first microfiber cleaning surface, i.e., the one encountered first in the process, can be moistened by a moistening device. Such a moistening device can consist of a fluid supply line connected to a pump and a fluid outlet near the microfiber cleaning surface. Such a moistening device serves to deliver cleaning fluid, such as demineralized water and/or alcohol or similar substances, to the microfiber cleaning surface. Demineralized water, in particular, strips foreign substances such as organic materials, for example oil and grease, from the surface of the glass pane, and these are then absorbed by the microfiber cleaning surface along with the water.

A second cleaning device having a second microfiber cleaning surface can be placed downstream from the first cleaning device. This second microfiber cleaning surface serves in particular to pick up the cleaning fluid and the foreign bodies dissolved in it, but also minuscule particles and liquid or viscous foreign bodies, from the glass surface.

In particular, the second microfiber cleaning surface is dried by a heater disposed at the run that is spatially separated from the glass surface, preferably the upper run. The heater can be controlled by a moisture sensor, which measures the moisture level of the microfiber cleaning surface and activates the heater as a function of that measurement value. Such a heater can have as its heat source one or more current-carrying electrical conductors, but also, alternatively, infrared sources aimed at the microfiber cleaning surface to be dried or lines carrying warm fluids such as water or air.

Before and/or after the cleaning of the surface by the microfiber cleaning surface, the glass surface can be cleansed of foreign bodies by means of brushes. These brushes can in particular be linear brushes, i.e., brushes comprising a belt-like brush element, on the outer side of which the filaments are mounted. By means of the brushes, relatively large foreign bodies, for example even those that do not dissolve in demineralized water, can be removed from the glass surface before it is cleaned by the microfiber cleaning surface. Suction devices are preferably disposed laterally to the glass surface to suction off excess fluids, loose foreign bodies and the like. These suction devices are disposed particularly before the cleaning by the microfiber cleaning surfaces and/or after the cleaning by the microfiber cleaning surfaces.

It is also possible to dispose one or more additional cleaning devices on the opposite side of the glass pane, thus making it possible to clean both surfaces of the glass pane simultaneously.

In one form thereof, the present invention provides a method for cleaning glass surfaces in which the glass surface is conveyed relative to a cleaning device, characterized in that the cleaning device moves a moistened microfiber cleaning surface over the glass surface and a second microfiber cleaning surface disposed downstream in the direction of movement of the glass surface is moved over the glass surface.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 shows a wiping element in perspective view;

FIG. 2 shows a wiping element in cross section; and

FIG. 3 shows a device for cleaning glass surfaces.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

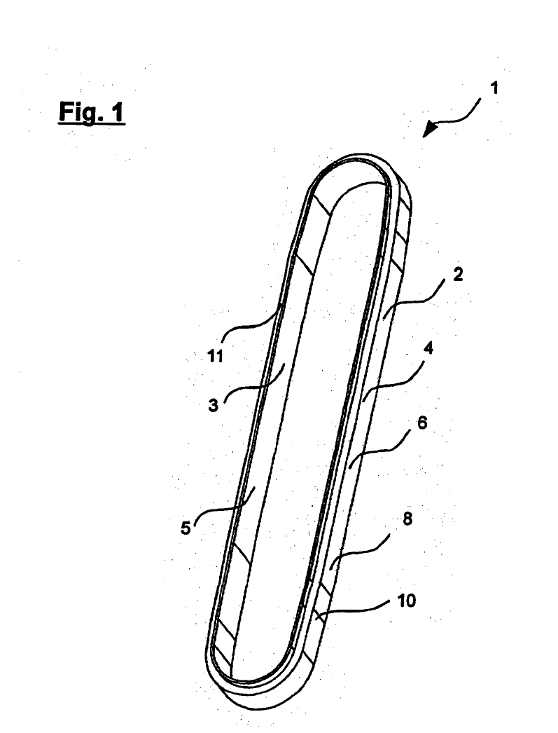

FIG. 1 shows a band-shaped wiping element 1 having a closed, annular shape. The wiping element 1 has an outer side 2 and an inner side 3. Extending along the outer side 2 is a microfiber cleaning surface 4 suitable for cleaning glass surfaces.

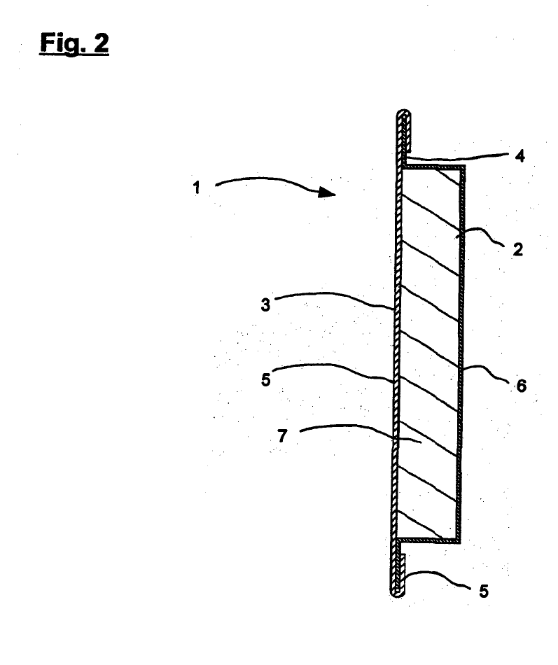

The inner side 3 of the wiping element 1 is formed by a base element 5. The base element 5 extends over the entire length and width of the wiping element 1 and is formed from an elastic material such as rubber with an embedded woven fabric. The outer side 2 of the wiping element 1 is divided into three regions. Thus, the wiping element 1 has a cleaning region 6 on its outer side 2, said cleaning region 6 extending along the circumference of the entire wiping element 1. Disposed on each side of the cleaning region is a respective guide region whose surface is formed, on the inner side and the outer side of the wiping element, by the base element 5, and thus constitutes a robust region. At these guide regions, the wiping element can be guided laterally by the cleaning device. The cleaning region 6 is formed by the microfiber cleaning surface 4, i.e., a textile made from microfibers, which is urged outward by a carrier body 7 (as illustrated in FIG. 2). The microfiber cleaning surface 4, supported by the carrier body 7, forms a cleaning surface 8 that contacts the glass surface during the cleaning of the glass surface. The carrier body 7, made from an elastic material such as foam, also extends along the circumference of the wiping element 1. The microfiber cleaning surface 4 is located on the top and sides of the carrier body 7 and is attached to the base body 3. The base body 3 covers the edges of the microfiber cleaning surface and thus prevents the edges of the microfiber cleaning surface from fraying or separating from the wiping element 1. The attachment of the microfiber cleaning surface to the base body 3 can be effected by welding, sewing, gluing and the like.

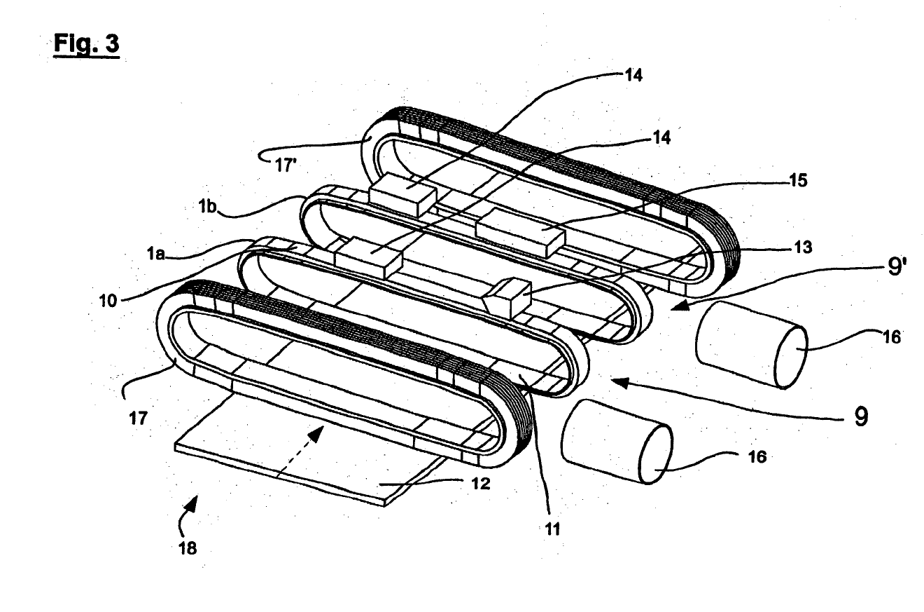

FIG. 3 shows a device 9 for cleaning glass surfaces in which the device 9 comprises a wiping element 1a that is tensioned between at least two rollers (not shown here) and thus forms an upper run 10 and a lower run 11.

The lower run 11 of the wiping element 1a is guided over the glass surface 12, such that the outer side 2 of the wiping element 1a contacts the glass surface 12 with the cleaning surface 8. Disposed at the upper run 10 of the wiping element 1 is a moistening device 13, which moistens the outer side 2 or cleaning surface 8 of the wiping element 1a with a cleaning fluid, such as demineralized water. For this purpose, the moistening device 13 includes one or more openings through which cleaning fluid is applied to the surface of the wiping element 1a. Disposed downstream in the direction of movement of the wiping element 1a is a moisture sensor 14 that measures the moisture level on the microfiber cleaning surface 4. The amount of cleaning fluid applied to the microfiber cleaning surface 4 of the wiping element 1a is controlled on the basis of this measurement value. The moisture sensor 14 can also be disposed upstream from the moistening device 13 in the direction of movement of the wiping element 1a, and thus can determine the amount of moisture that is necessary and still lacking and control the moistening device 13 accordingly.

Disposed downstream from the first cleaning device 9 in the direction of movement of the glass surface 12 is a second cleaning device 9′ having a wiping element 1b similar to wiping element 1a of the first cleaning device 9. Wiping element 1b also comprises a cleaning region 6 provided with a microfiber cleaning surface 8. This wiping element 1b also forms an upper run 10 and a lower run 11, the lower run 11 being guided on the glass surface 12. The two rollers (not shown here) that drive or tension the wiping element 1b are disposed laterally above the glass surface 12. Disposed at the upper run 10 is a heater 15, which heats and thereby dries the outer side 2 and/or the microfiber cleaning surface 4 of the wiping element 1b. Also disposed at the upper run is a moisture sensor 14, which controls the heater as a function of the moisture level that prevails on the outer side 2 or microfiber cleaning surface 8 of wiping element 1b.

A blower 16 is disposed laterally to the glass surface before the first cleaning device 9, to remove some of the cleaning fluid, solid foreign bodies, etc., from the surface by suction. A linear brush 17 can be disposed in advance of the suctioning, particularly in advance of the first cleaning device 9, to remove particles from the glass surface and thus prevent rapid fouling of the wiping elements 1a, 1b. Another brush 18, such as a linear brush, can be disposed after the drying by wiping element 1b, to perform a final cleaning of the glass surface.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

Reference Numerals

| | |
|---|---|
| Wiping element | 1 |
| Wiping element of first device | 1a |
| Wiping element of second cleaning device | 1b |
| Outer side | 2 |
| Inner side | 3 |
| Microfiber cleaning surface | 4, 4′ |
| Base element | 5 |
| Cleaning region | 6 |
| Carrier body | 7 |
| Cleaning surface | 8 |
| First cleaning device | 9 |
| Second cleaning device | 9′ |
| Upper run | 10 |
| Lower run | 11 |
| Glass surface | 12 |
| Moistening device | 13 |
| Moisture sensor | 14 |
| Heater | 15 |
| Blower | 16 |
| Linear brush | 17, 17′ |
| Cleaning system | 18 |

1-10. (canceled)

11. A method for cleaning glass surfaces, comprising the steps of:
conveying a glass surface relative to a cleaning device;
moving a first, moistened microfiber cleaning surface over the glass surface; and
moving a second microfiber cleaning surface over the glass surface, the second microfiber cleaning surface disposed downstream of the first microfiber cleaning surface in a direction of conveyance of the glass surface.

12. The method of claim 11 wherein said moving steps further comprise moving at least one of the first and second microfiber cleaning surfaces rectilinearly over the glass surface.

13. The method of claim 11, wherein at least one of the microfiber cleaning surfaces comprises a portion of a belt-shaped, closed wiping element.

14. The method of claim 13, wherein the wiping element is tensioned between at least two rollers with the wiping element forming at least two runs and wherein, in a said moving step, one of the runs contacts one of the first and second microfiber cleaning surfaces with the glass surface.

15. The method of claim 11, wherein said first moving step further comprises moistening the first microfiber cleaning surface using a moistening device.

16. The method of claim 11, wherein said second moving step further comprises drying the second microfiber cleaning surface using a heater.

17. The method of claim 11, wherein said second moving step further comprises drying the glass surface using the second microfiber cleaning surface.

18. The method of claim 11, further comprising the additional step of cleaning the glass surface using a linear brush.

19. A device for cleaning glass panes, comprising:
a conveying device for conveying a glass pane having a surface;
a cleaning device including a first microfiber cleaning surface movable over the surface of the glass pane and a second microfiber cleaning surface movable over the surface of the glass pane and disposed downstream of the first microfiber cleaning surface in a direction of conveyance of the glass pane, wherein a direction of movement of said first microfiber cleaning surface and the direction of conveyance of the glass pane form an angle.

20. The device of claim 19, wherein at least one of said first and second microfiber cleaning surfaces form a portion of a wiping element guided between at least two rollers transversely to the direction of conveyance of the glass pane.
